(19) United States
(12) Patent Application Publication
(10) Pub. No.: US 2023/0274353 A1
(43) Pub. Date: Aug. 31, 2023

(54) PLATFORM AND GRAPHIC USER INTERFACE (GUI) FOR TRADING CORPORATE BOND DERIVATIVES

(71) Applicant: Ran Moshe ZION, Holon (IL)

(72) Inventor: Ran Moshe ZION, Holon (IL)

(21) Appl. No.: 18/109,893

(22) Filed: Feb. 15, 2023

(30) Foreign Application Priority Data
Feb. 28, 2022 (IL) 290982

(51) Int. Cl. G06Q 40/04

(52) U.S. Cl. CPC G06Q 40/04

(57) ABSTRACT

Disclosed herein is a platform for trading corporate bonds based derivatives executed by server(s) connected, via network(s), to a plurality of client devices comprising executing trading software agents of the platform. The platform comprising a computing engine for computing (1) average spread yield of one or more baskets of corporate bonds by averaging individual spread yields of the corporate bonds included in the respective basket, and (2) adjusted average spread duration of each basket averaging individual spread durations of the corporate bonds included in the respective basket, a render engine for instructing a GUI of the trading software agents to display the average spread yield and the adjusted average spread and best bids/offers, and a trade engine for receiving from the client devices offers and bids for derivative contract(s) relying on the average spread yield of the basket(s), and creating the derivative contracts by brokering between the offers and bids.

### RELATED APPLICATION

This application claims the benefit of priority of Israel Patent Application No. 290982 filed on Feb. 28, 2022, the contents of which are incorporated by reference as if fully set forth herein in their entirety.

### FIELD AND BACKGROUND OF THE INVENTION

The present invention, in some embodiments thereof, relates to systems and methods for trading derivative contracts relying on corporate bonds and, more particularly, but not exclusively, to platform and GUI for trading derivative contracts relying on baskets of corporate bonds, each basket comprising a plurality of corporate bonds sharing similar maturation periods.

Derivatives trade is a major product in the financial arena and may rely on a plurality of underlying assets ranging from financial assets such as bonds, stock, indexes and/or the like to commodities and physical product based indexes.

A derivative, is a product that relies on the underlying asset and traded between traders in an exchange and/or Over the Counter (OTC).

One of the prominent derivative markets is the treasury bonds market where derivatives that rely on the yield of government issued bonds are traded in high daily volumes.

Since the derivatives trade, similar to other trade fields, is done between traders, tools, systems and user interfaces, specifically Graphical User Interfaces (GUI) employed to enable and support the derivatives trade are therefore highly instrumental for effective, efficient and reliable trade.

### SUMMARY OF THE INVENTION

According to a first aspect of the present invention there is provided a platform for trading corporate bonds based derivatives, comprising one or more servers connected, via one or more networks, to a plurality of client devices each comprising one or more processors and memory for executing a receptive one of a plurality of trading software agents of a corporate bonds derivatives trading platform. The one or more servers comprising one or more processors and a memory for executing the corporate bonds derivatives trading platform. The corporate bonds derivatives trading platform comprising:
A computing engine configured to compute an average spread yield of each of one or more baskets of corporate bonds with predefined maturation periods, the average spread yield averages a plurality of individual spread yields of a plurality of corporate bonds included in the basket, each of the plurality of individual spread yields is computed with respect to a treasury yield curve, and an adjusted average spread duration of each of the one or more baskets averaging a plurality of individual spread durations of the plurality of corporate bonds included in the respective basket.
A render engine configured to instruct a graphical user interface (GUI) of the plurality of trading software agents to display the average spread yield and the adjusted average spread duration of the one or more baskets for the predefined maturation period and best bids and offers for the average spread yield.
A trade engine configured to receive from at least some of the plurality of client devices a plurality of offers and bids for one or more derivative contracts relying on the average spread yield of the one or more baskets, and create the one or more derivative contracts by brokering between the plurality of offers and bids.

According to a second aspect of the present invention there is provided a computer based method of trading corporate bonds based derivatives, comprising using one or more servers connected via one or more networks to a plurality of client devices each executing a respective one of a plurality of trading software agents of a corporate bond derivatives trading platform. The one or more servers comprising one or more processors and memory for executing the corporate bonds derivatives trading platform. The corporate bonds derivatives trading platform comprising:
A computing engine configured to compute an average spread yield of each of one or more baskets of corporate bonds with predefined maturation periods, the average spread yield averages a plurality of individual spread yields of a plurality of corporate bonds included in the basket, each of the plurality of individual spread yields is computed with respect to a treasury yield curve, and an adjusted average spread duration of each of the one or more baskets averaging a plurality of individual spread durations of the plurality of corporate bonds included in the respective basket.
A render engine configured to instruct a graphical user interface (GUI) of the plurality of trading software agents to display the average spread yield and the adjusted average spread duration of the one or more baskets for the predefined maturation period and best bids and offers for the average spread yield.
A trade engine configured to receive from at least some of the plurality of client devices a plurality of offers and bids for one or more derivative contracts relying on the average spread yield of the one or more baskets, and create the one or more derivative contracts by brokering between the plurality of offers and bids.

In an optional implementation form of the first and/or second aspects, a plurality of baskets are created for a plurality of different maturation periods, each of the plurality of baskets comprises a plurality of corporate bonds, and computing a respective average spread yield and a respective adjusted average spread duration for each of the plurality of baskets serving as a relying asset for one or more of a plurality of derivative contracts.

In a further implementation form of the first and/or second aspects, each of the one or more baskets of corporate bonds comprises a plurality of corporate bonds issued by a plurality of corporates, each of the plurality of corporate bonds has a maturation period which is within a predefined range extending a predefined time period before and after the predefined maturation period.

In a further implementation form of the first and/or second aspects, no change is applied to a composition of each of the one or more basket from a day of creation of the one or more baskets until an expiration day of the one or more derivative contracts relying on the one or more baskets.

In a further implementation form of the first and/or second aspects, each of the one or more baskets of corporate bonds expires at an expiration day of the one or more derivative contract relying on the respective basket.

In a further implementation form of the first and/or second aspects, the average spread yield is computed for each of the one or more baskets based on a weighted average of the plurality of individual spread yields included in the respective basket. Each of the plurality of individual spread yields computed for a respective one of the plurality of corporate bonds is assigned a weight according to a value of the respective corporate bond. The weight of each corporate bond is computed based on a market value of the respective corporate bond with respect to a market value of the entire respective basket.

In a further implementation form of the first and/or second aspects, the adjusted average spread duration is computed for each of the one or more basket based on a weighted average of the plurality of individual spread durations. Each of the plurality of individual spread durations computed for a respective one of the plurality of corporate bonds is assigned a weight according to a value of the respective corporate bond. The weight is computed based on a market value of the respective corporate bond with respect to a market value of the entire respective basket.

In a further implementation form of the first and/or second aspects, each of the one or more baskets comprises a plurality of bonds each issued in an issue complying with one or more predefined inclusion criteria.

In a further implementation form of the first and/or second aspects, each of the plurality of corporate bonds included in each of the one or more basket has a call-out period which is smaller than a predefined period before the maturity date of the respective corporate bond.

In a further implementation form of the first and/or second aspects, a compensation for each corporate bond pulled-out from the one or more baskets is computed according to one or more compensation rules.

In a further implementation form of the first and/or second aspects, the one or more derivative contracts are members of a group consisting of: a future contract, a forward, and/or a swap.

In a further implementation form of the first and/or second aspects, the one or more derivative contracts are Non-Deliverable Forward (NDF) type contracts.

In an optional implementation form of the first and/or second aspects, one or more new baskets of corporate bonds, serving as a relying asset for one or more new derivative contracts, are created to replace the one or more baskets. The one or more new baskets correspond to the maturation periods of the one or more baskets.

In a further implementation form of the first and/or second aspects, the one or more new baskets are created at a predefined time before expiration of their respective one or more baskets. The one or more new baskets having adjusted maturation periods compared to the maturation period their respective one or more baskets to compensate for the time duration between a creation time of the respective new basket and the creation time of the respective basket.

In a further implementation form of the first and/or second aspects, during a lifetime of the one or more derivative contracts until expiration of the one or more derivative contracts. A transaction price of the one or more derivative contracts is computed based on the adjusted average spread duration of the basket on which the one or more derivative contracts rely. The adjusted average spread duration of the basket is computed based on a date of the trade day and an agreed average spread yield of the one or more baskets on which one or more of the derivative contract rely. The agreed average spread yield is negotiated between counterparties of a transaction of the one or more derivative contracts.

In a further implementation form of the first and/or second aspects, at expiration day of the one or more derivative contracts, a settlement price of the one or more derivative contracts is computed based on the computed average spread yield of the one or more baskets and the computed adjusted average spread duration of the one or more baskets.

In a further implementation form of the first and/or second aspects, the average spread yield of the one or more baskets is computed at the expiration day of the one or more derivative contracts based on one or more of: the value of the average spread yield computed at an end of trading day at the expiration day, and/or an average of a plurality of samples of the value of the average spread yield computed at a plurality of times during the trading day at the expiration day.

In an optional implementation form of the first and/or second aspects, the one or more derivative contracts are considered zero-coupon contracts.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks automatically. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of methods and/or systems as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars are shown by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of an exemplary process of trading corporate bonds market derivatives based on baskets of corporate bonds serving as underlying assets for derivative contracts, according to some embodiments of the present invention;

FIG. 2A and FIG. 2B are schematic illustrations of an exemplary system for trading corporate bonds market derivatives based on baskets of corporate bonds serving as underlying assets for derivative contracts, according to some embodiments of the present invention;

FIG. 3 is a graph chart of a yield curve of exemplary US government treasury bonds;

FIG. 4 is a graph chart of a yield curve of an exemplary corporate company bond vs. US government treasury bonds;

FIG. 5 is a graph chart of spread yield vs. maturity for a plurality of corporate companies, according to some embodiments of the present invention;

FIG. 6 is a graph chart of spread yield vs. maturity for a plurality of corporate companies illustrating a plurality of baskets of corporate bonds created to serve as underlying assets for derivative contracts, according to some embodiments of the present invention;

FIG. 7 is a graph chart illustrating a spread yield curve created for corporate bonds market based on spread yield computed for a plurality of baskets of corporate bonds, according to some embodiments of the present invention;

FIG. 8 is a graph chart illustrating trading information visualization for derivative contracts relying on a spread yield computed for a plurality of baskets of corporate bonds, according to some embodiments of the present invention;

FIG. 9 is a graph chart expressing price computation of a derivative contract relying on an average spread yield of a basket of corporate bonds, according to some embodiments of the present invention; and

FIG. 10 is a graph chart expressing an average spread yield of an exemplary corporate bond index vs. a spread of a CDX index, both having similar maturation periods, according to some embodiments of the present invention.

### DETAILED DESCRIPTION OF SPECIFIC EMBODIMENTS OF THE INVENTION

The present invention, in some embodiments thereof, relates to systems and methods for trading derivative contracts relying on corporate bonds and, more particularly, but not exclusively, to platform and GUI for trading derivative contracts relying on baskets of corporate bonds, each basket comprising a plurality of corporate bonds sharing similar maturation periods.

Derivatives (interchangeably designated derivative contracts herein after) are financial products playing a major part in many trade arenas. Derivatives rely on underlying assets on which the derivative's price is based. The underlying assets may include financial assets, such as bonds, stock, financial and/or economic indexes, interest rates and more as well as commodities and/or other products.

One of the major derivatives trading arenas is the bonds derivatives that rely on bonds issued by governments (also known as treasuries) such as, for example, United States (US) treasury bonds. However, while derivatives relying on government issued bonds, are highly traded, the trade of derivatives relying on corporate issued bonds is used in significantly lower volumes, typically a very small fraction compared to the treasury bonds derivatives trade.

The low volume trade of corporate bonds derivatives compared to the treasury derivatives may be attributed to some core differences in their formation. The trade of corporate bonds based derivatives that currently exists is typically done in order to trace the total return performance of a corporate bond index, created by collecting a plurality of Corporate bonds with vast ranges of maturation periods (time to maturity) issued by a plurality of companies. This is on contrast to the space of treasury derivatives where each derivative corresponds to a yield relating to a specific maturation period. That is done by relying each derivative on a specific treasury bond that matches the desired maturation period (e.g. 2 yr yield, 5 yr yield, 7 yr, 10 yr etc.). A tradable treasury yield curve may be therefore created for the treasury bonds market over the plurality of maturation periods which may enable traders and other market participants to trade different parts of the treasury yield curve, shift exposure from one part of the curve to another, and also take exposure on the shape of the treasury yield curve (e.g. steepening or flattening position of the yield curve). As of date, such trading capabilities are not available over the spread yield curve of the corporate bonds market.

The answer as to why such derivatives are not available in the corporate bond markets today, may be explained by the vast differences in each of the markets, as detailed hereinafter.

While the government has a single credit rating (e.g. AAA for the US government) the plurality of corporate companies may have many different credit ratings ranging from C to AAA. Moreover, the treasury bonds are associated with a single sector, namely government, while the corporate bonds are issued by a plurality of corporate bonds from a plurality of different sectors, for example, finance, industry, energy, utilities, and many more. Furthermore, while the government may issue treasury bonds in a significantly limited number of issues (for example, 200), there may be hundreds of different corporate companies issuing bonds in a plurality of issues such that the corporate bonds issues may reach thousands of issues. In addition, while each treasury bonds issue may be very large in volume (size), for example, in the US the average issue is around 70 billion USD, the size of each of the corporate bonds issues may be typically less than one billion USD.

Due to the above mentioned differences, it may be impossible to assign a single corporate bond (similar to the method in the treasuries market) to serve as an effective underlying asset for a derivative, representing the spread yield of the corporate bond market for a specific time to maturity.

According to some embodiments of the present invention, there are provided methods, systems and computer program products to facilitate tools, infrastructures and platforms to enable traders to effectively trade derivative contracts, for example, a future contract, a forward, a swap and/or the like relying on the corporate bonds market.

A corporate bonds derivatives trading platform executed by one or more servers, services, cloud platforms and/or the like may communicate with a plurality of client devices used by a plurality of traders.

Each of client devices may execute a trading software (SW) agent having a Graphic User Interface (GUI) configurable to display trading information received from the corporate bonds derivatives trading platform which relate to the trade of derivative contracts relying on the corporate bonds market. Moreover, via the trading SW agents the traders may issue offers and bids for one or more derivative contracts which may be brokered by the corporate bonds derivatives trading platform to create one or more derivative contracts accordingly.

As known in the art, it is common to trade a corporate bond of a single corporate company first, based on the spread between the yield of the company's bond with respect to the yield of a corresponding treasury bond having a similar maturation period, designated herein after the spread yield component, or spread yield in short, and thereafter agree on the level of the treasury component embedded in the corporate bond.

Extending the concept of trading of the spread yield (component) concept, the corporate bonds derivatives trading platform may create one or more baskets of corporate bonds each for a respective maturation period. The corporate bonds derivatives trading platform may then compute an average spread yield and an adjusted average spread duration for each of the baskets by averaging the individual spread yields and individual spread durations of all of the corporate bonds included in the respective basket.

The average spread yield computed for each basket may serve as the underlying asset for one or more derivative contracts created for the maturation period of the respective basket. The basket may be therefore maintained for the lifetime of the relying derivative contract, for example, 3 months, 6 months, 12 months and/or the like.

The corporate bonds derivatives trading platform may create each basket having a receptive maturation period by including in each basket a plurality of corporate bonds having maturation periods which are a substantially similar to the maturation period of the basket. The corporate bonds derivatives trading platform may apply one or more inclusion criteria for selecting the corporate bonds to be included is the baskets at their creation day. These inclusion criteria may define, for example, a minimal credit rating of the issuing company, a minimal size of the issue, a minimal daily trade volume of the bond, and/or the like.

The corporate bonds derivatives trading platform may share (transmit) the computed average spread yield and an adjusted average spread duration of the baskets to the plurality of traders using their client devices each executing the trading SW agent. The corporate bonds derivatives trading platform may transmit additional trading information to the client devices, for example, best offers and bids for each derivative contract and/or the like.

The trading SW agents executed by the client devices may adjust and/or instruct their GUI to display the average spread yield, the adjusted average spread duration of the baskets and the trading information to the traders.

Based on the average spread yield and the adjusted average spread duration of the baskets, typically also based on additional market conditions and factors, one or more of the traders, using the trading SW agent, may place one or more offers and/or bids for one or more derivative contracts. The client devices may then transmit the traders offers and bids placed by the traders to the corporate bonds derivatives trading platform.

The corporate bonds derivatives trading platform brokering between the offers and bids may create one or more of the derivative contracts accordingly, i.e., based on matched offers and bids.

The corporate bonds derivatives trading platform may further maintain continuity of trading the spread yields of the baskets serving as the underlying asset for the derivative contracts by replacing expired baskets (expiring in the same day of the relying derivative contract) with new ones and computing the average spread yield for the new baskets. The average spread yield computed for the new baskets may therefore serve as the underlying asset for one or more new derivative contracts. Moreover, in order to marinating smooth continuity, the corporate bonds derivatives trading platform may create the new baskets in advance before the time of expiration of the existing basket.

As described herein after in detail, various issues relating to the trade of corporate bonds market based derivatives contracts are addressed and resolved, for example, pricing of the derivatives during the lifetime of the derivative and at its expiration date, types of corporate bonds included in the baskets, maintaining the continuation of the underlying average spread yield and more.

Deploying the corporate bonds derivatives trading platform and its extension trading SW agent GUI to enable traders to effectively trade derivative contracts relying on the average spread yield of baskets of corporate bonds for different maturation periods may present major advantages and benefits.

First, trading the corporate bonds market derivatives may significantly increase liquidity of the corporate bonds which typically suffer from low liquidity due to low trade volumes. Creating an effective, reliable and representative underlying asset for the corporate bonds market, namely the baskets of corporate bonds, may attract traders to increase their investment in the corporate bonds market derivatives financial instrument thus significantly increasing the trade volume of corporate bonds as may be seen in the treasury bonds market.

Moreover, trading corporate bonds market derivatives using derivatives relying on the spread yield of a single corporate bond may be inefficient and practically impossible since no single corporate bond may be representative of the entire corporate bond market. Moreover, liquidity of each individual corporate bond may be significantly low due to its low daily trade volume further making it unrealistic to use any single corporate bond as the underlying asset for corporate bond market derivatives.

Furthermore, what is common to all existing corporate bonds derivatives is that they all aim to replicate the total return of an underlying corporate index. This may present two major deficiencies. First, buying or selling such derivatives may give exposure to the bonds included in the index with vast range of maturation periods. Therefore, unlike the treasury market, it may be impossible to trade different maturation period points over a spread yield curve of the corporate bond market. Second, as the existing corporate bonds derivatives are a total return instrument, they also include the performance of the treasury component embedded in corporate bonds, and hence may not accommodate a market that is driven by trading mainly the spread yield of a corporate bond, especially in the US. These facts make current existing corporate bonds derivatives highly ineffective in addressing the specific needs of the corporate bonds market participants and thus little used if at all.

In contrast, the corporate bonds derivatives trading platform may create baskets of corporate bonds for a plurality of maturation periods, each basket consists of bonds within a predefined range of the maturation period of the basket. Then, by computing each basket's average spread yield and assigning derivatives to the computed spread yields, a tradable spread yield curve may be created. Based on the spread yield curve, the traders may easily and efficiently shift their spread yield positions and exposure between derivative contracts corresponding to different maturation periods as done in the treasury bonds market. Since the spread yield curve of the corporate bond market may react to various economic data in a different magnitude and/or direction to the treasury yield curve, (e.g., an anticipated recession may bull-flatten the treasury yield curve while in contrary bear-steepen the corporate spread yield curve) presenting the ability to trade the spread yield curve via current invention, may be extremely effective and essential for corporate bond market participants.

In addition, facilitating the ability to trade the spread yield curve of the corporate bond market via derivatives, also enables market participants to make short positions in different parts of the spread yield curve, whereas shorting the underlying assets directly involves borrowing them first, which may be very costly and sometimes impossible. Also, since the average spread yield of the baskets of corporate bonds serving as the underlying asset expresses the spread between the corporate bonds market and the treasury bonds market, the average spread yield may express the confidence and/or risk estimated for the corporate bonds compared to the treasury bonds. The traders may therefore efficiently shift their positions and exposure based on their estimation of the spread yield component alone, through corporate bonds market derivative contracts, without the need to trade separately with treasury bonds and corporate bonds. This may present another useful advantage, as traders may focus only on managing the exposure related to the risk associate with corporates (spread yield risk), without the need to also manage the treasury component embedded in a corporate bond and thus, further reduce resources, for example, computing resources, time, effort, capital and/or the like involved in trading the embedded treasury component of the corporate bond based derivatives.

Configuring the GUI of the trading SW agents, which may be considered as extensions of the corporate bonds derivatives trading platform, to clearly visualize the average trade spread and the additional trading information to the traders may significantly increase the user experience of the traders.

Finally, computing the average spread yield and the adjusted average spread duration for the baskets of corporate bonds, each basket including only a subset of corporate bonds having maturation periods which are significantly similar (within the range) to the maturation period of the basket, may significantly reduce the computing resources, for example, processing resources, storage resources, networking resources, and/or the like. This is since the average spread yield and the adjusted average spread duration are compute by averaging only corporate bonds which comply with the inclusion criteria of the tight maturation period range, as opposed to computing an underlying corporate bonds index for a huge number of corporate bonds, with numerous different maturation periods, as may be done by the existing methods. Therefore, for example, assuming four baskets are created for four maturation periods (e.g. 2 years, 5 years, 7 years, 10 years) where each baskets comprises a subset of, 200 bonds for example, thus resulting in a total of 800 bonds may significantly reduce the computing resources required to compute the average spread yield and the adjusted average spread duration compared to the existing methods, for example, the Chicago Board Options Exchange (CBOE) corporate credit futures which traces the total return of the iBoxx USD investment grade corporate benchmark index which has more than 2500 bonds or the Bloomberg total return swap that traces the Bloomberg US corporate index with about 7000 bonds.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer program code comprising computer readable program instructions embodied on a computer readable medium may be transmitted using any appropriate medium, including but not limited to wireless, wire line, optical fiber cable, RF, etc., or any suitable combination of the foregoing.

The computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

The computer readable program instructions for carrying out operations of the present invention may be written in any combination of one or more programming languages, such as, for example, assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

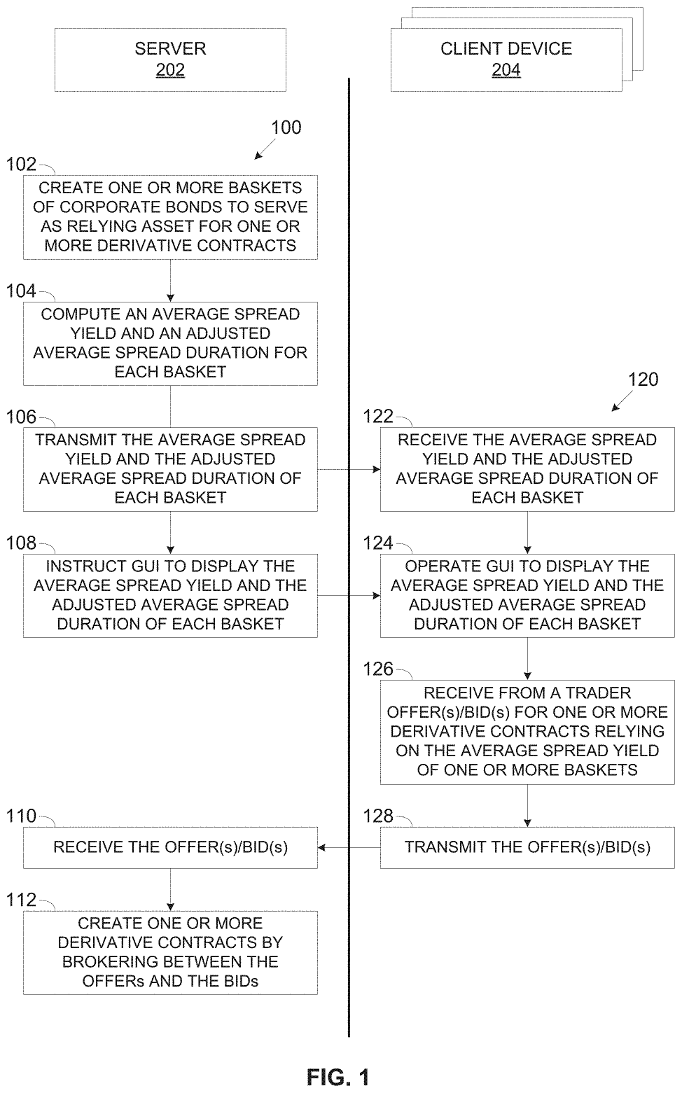

Referring now to the drawings, FIG. 1 illustrates a flowchart of an exemplary process of trading corporate bonds market derivatives based on baskets of corporate bonds serving as underlying assets for derivative contracts, according to some embodiments of the present invention.

An exemplary process 100 may be executed by a server 202 hosting a corporate bonds derivatives trading platform to create one or more baskets of corporate bonds which may serve as underlying assets for derivatives contracts (e.g., future contract, forward, swap, etc.) traded between a plurality of traders.

In particular, the corporate bonds derivatives trading platform executed by the server may create each basket for a certain basket maturation period and may include in each basket a plurality of corporate bonds having maturation periods which are a substantially similar to the basket maturation period. The corporate bonds derivatives trading platform may compute an average spread yield and an adjusted average spread duration for each basket by averaging the individual spread yields and spread durations respectively of all of the corporate bonds included in the respective basket.

The corporate bonds derivatives trading platform may share (transmit) the average spread yield and an adjusted average spread duration of the baskets to a plurality of traders using client devices 204 each executing a trading software (SW) agent.

Each of the trading SW agents executed by the client devices 204 may execute an exemplary process 120 to display the average spread yield and the adjusted average spread duration of the baskets to the traders and transmit to the corporate bonds derivatives trading platform offers and bids in basis points yield units, placed by the traders for one or more derivatives contracts based on the average spread yield of one or more of the baskets.

The corporate bonds derivatives trading platform brokering between the offers and bids may create one or more derivative contracts accordingly.

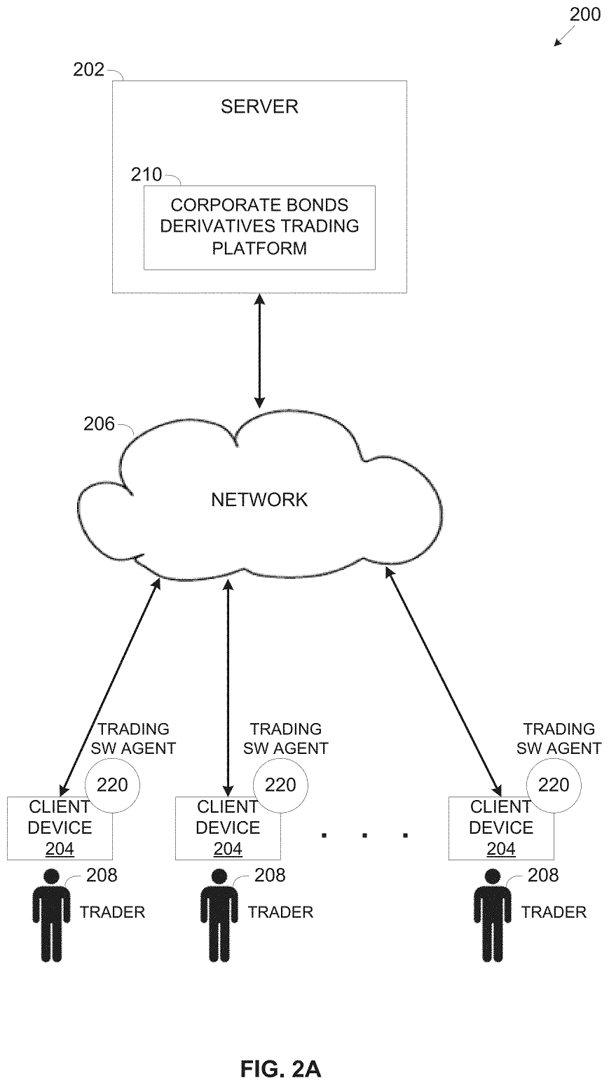

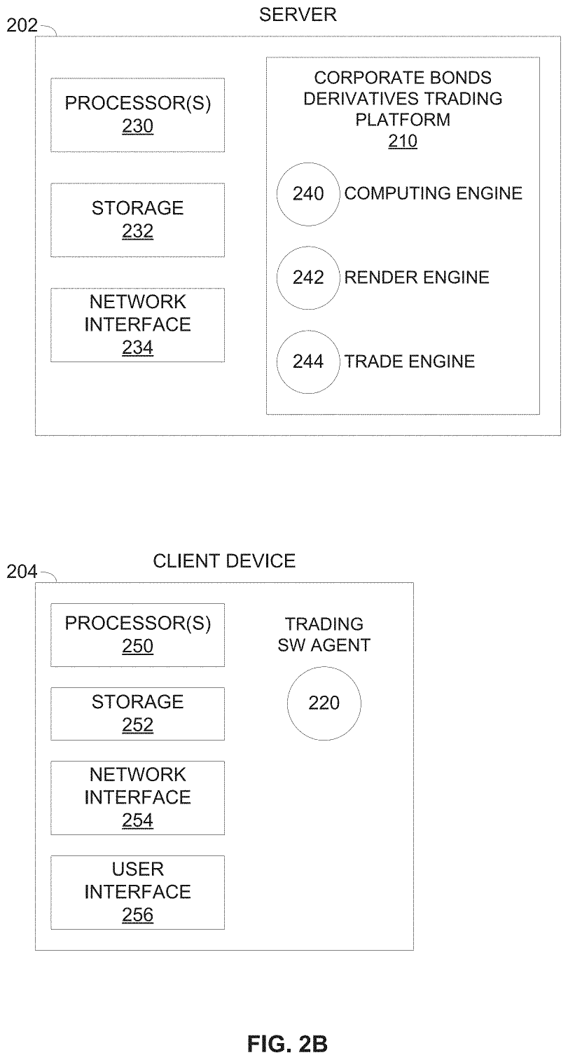

Reference is also made to FIG. 2A and FIG. 2B, which are schematic illustrations of an exemplary system for trading corporate bonds market derivatives based on baskets of corporate bonds serving as underlying assets for derivative contracts, according to some embodiments of the present invention.

As seen in FIG. 2A, an exemplary system 200 for trading corporate bonds market derivatives may comprise the server 202 which may be configured to execute a corporate bonds derivatives trading platform 210. The corporate bonds derivatives trading platform 210 executing the process 100 may communicate with the plurality of client devices 202 via a network 206 comprising one or more wired and/or wireless networks, for example, a Local Area Network (LAN), a Wireless LAN (WLAN, e.g. Wi-Fi), a Wide Area Network (WAN), a Metropolitan Area Network (MAN), a cellular network, the internet and/or the like.

Each of the plurality of client devices 204 used by a respective one of a plurality of traders 208 may execute a trading SW agent 210 configured to execute the process 120. This means that the plurality of client devices 204 may each execute a respective instance of the trading SW agent 210 such that each of the client devices 204 may execute the process 120.

As seen in FIG. 2B, the server 202, for example, a server, a computing node, a cluster of computing nodes and/or the like may include a processor(s) 230, a storage 232 for storing code (program store) and/or data and a network interface 234 for connecting to the network 206. For brevity, the server 202 is addressed herein after in singular form. This, however, should not be construed as limiting since the server 202 may include a plurality of servers.

Via the network interface 234 comprising one or more wired and/or wireless network adapters, the server 202 may communicate with the client devices 204. The processor(s) 230, homogenous or heterogeneous, may include one or more processing nodes arranged for parallel processing, as clusters and/or as one or more multi core processor(s). The storage 232 may include one or more non-transitory memory devices, either persistent non-volatile devices, for example, a ROM, a Flash array, a hard drive, an SSD, a magnetic disk and/or the like as well as one or more volatile devices, for example, a RAM device, a cache memory and/or the like. The storage 232 may further comprise one or more local and/or remote network storage resources, for example, a storage server, a Network Attached Storage (NAS), a network drive, a cloud storage service and/or the like accessible via the network interface 234.

The processor(s) 230 may execute one or more software modules, for example, a process, a script, an application, an agent, a utility, a tool, an Operating System (OS), a service, a plug-in, an add-on and/or the like each comprising a plurality of program instructions stored in a non-transitory medium (program store) such as the storage 232 and executed by one or more processors such as the processor(s) 230.

Optionally, the processor(s) 230 includes, utilizes and/or applies one or more hardware elements available in the server 202, for example, a circuit, a component, an Integrated Circuit (IC), an Application Specific Integrated Circuit (ASIC), a Field Programmable Gate Array (FPGA), a Digital Signals Processor (DSP), a Graphic Processing Unit (GPU) and/or the like.

The processor(s) 230 may therefore execute one or more functional modules utilized by one or more software modules, one or more of the hardware modules and/or a combination thereof. In particular, the processor(s) 230 may execute the corporate bonds derivatives trading platform 210 functional module which may be constructed of one or more lower level functional modules.

For example, the corporate bonds derivatives trading platform 210 may comprise a computing engine 240 functional module configured to execute at least part of the process 100, for example, computing the average spread yield and/or the adjusted average spread duration of the baskets, and/or the like. In another example, the corporate bonds derivatives trading platform 210 may comprise a render engine 242 functional module configured to communicate with the client devices 204, specifically with the trading SW agents 210 executed by the client devices 204 to instruct display of the average spread yield and/or the adjusted average spread duration of the baskets to the traders 208. In another example, the corporate bonds derivatives trading platform 210 may comprise a trade engine 244 functional module configured to communicate with the trading SW agents 210 to receive offers and bids placed by the traders 208 for one or more derivative contracts and create one or more derivative contracts by brokering between the received offers and bids.

Each of the client devices 204, for example, a computer, a laptop, a tablet, a Smartphone, and/or the like may include a processor(s) 250 such as the processor(s) 230, a storage 252 for storing code (program store) and/or data, a network interface 254 such as the network interface 234 for connecting to the network 206 and a user interface 256 for interacting with a respective trader (user) 208.

The user interface 256 may include one or more Human-Machine Interfaces (HMI) for interacting with the trader 208, for example, a keyboard, a touchpad, a pointing device e.g. mouse, trackball, joystick, touch surface, pointing stick, etc.), a touchscreen, a screen, a digital pen, a speaker, an earphone, a microphone and/or the like.

The processor(s) 250 may execute one or more software modules each comprising a plurality of program instructions stored in a non-transitory medium (program store) such as the storage 252 and executed by one or more processors such as the processor(s) 250. Optionally, the processor(s) 250 includes, utilizes and/or applies one or more hardware elements available in the client device 204, for example, a circuit, a component, an IC, an ASIC, an FPGA, a DSP, a GPU and/or the like.

The processor(s) 250 may therefore execute one or more functional modules utilized by one or more software modules, one or more of the hardware modules and/or a combination thereof. For example, the processor(s) 250 may execute the trading SW agent 210 for communicating with the corporate bonds derivatives trading platform 210 executed by the server 202. The trading SW agent 210 may further comprise a Graphical User Interface (GUI) utilizing the user interface 256 to interact with the trader 208, for example, display trading data received from the corporate bonds derivatives trading platform 210, receive trading commands from the trader 208 and/or the like.

The trading SW agent 210 may be utilized, implemented and/or facilitated using one or more designs, methodologies and/or deployments. For example, the trading SW agent 210 may comprise a locally executed application configured to communicate with the corporate bonds derivatives trading platform 210. In another example, the trading SW agent 210 may comprise a web browser for communicating with the corporate bonds derivatives trading platform 210 and/or one or more other servers, services and/or websites controlled by the corporate bonds derivatives trading platform 210 (collectively designated corporate bonds derivatives trading platform 210). The web browser browsing the corporate bonds derivatives trading platform 210 may render one or more webpages of the corporate bonds derivatives trading platform 210 to access one or more applications executed by the corporate bonds derivatives trading platform 210.

Optionally, the corporate bonds derivatives trading platform 210 and/or one or more of its components, for example, the computing engine 240, the render engine 242 and/or the trade engine 244 may be utilized by one or more cloud computing services, platforms and/or infrastructures such as, for example, Infrastructure as a Service (IaaS), Platform as a Service (PaaS), Software as a Service (SaaS) and/or the like provided by one or more vendors, for example, Google Cloud, Microsoft Azure, Amazon Web Service (AWS) and Elastic Compute Cloud (EC2), IBM Cloud, and/or the like.

Before going into further detail of the present invention, some background is provided for corporate and treasury bonds (treasuries) markets. The background as well as some embodiment of the present invention described hereinafter are demonstrated via US markets but are applicable for other markets such as the European, UK and other bond markets.

The US Investment Grade Corporate bond market is a huge market summing up to almost 7 trillion dollars. However, one of its prominent deficiencies is its lack of liquidity. Average daily traded volume in this market is only about 30 Billion dollars a day which is about 0.3% of the market. For comparison, the treasuries market (bonds issued by the government of the united states) amounts to 19 trillion dollars and the daily traded volume is around 550 Billion USD which is almost about 3% of the Market. Liquidly in the treasury market, in terms of percentage share of market traded, is therefore 10 times larger than in the US corporate market.

Moreover, trading future derivatives forms another acceptable and efficient way to trade the US treasuries market which may further increase liquidity of the US treasury market. The future derivatives traded at the Chicago Mercantile Exchange (CME) futures exchange are typically traded according to several main futures reflecting different maturation period, i.e., 2 years, 5 years, 10 years (with about 7 years effective duration), 10 years ultra, 20 years and 30 years. These futures add an additional daily volume of about 330 Billion USD in face value terms, summing up the daily traded volume to about 5% of the treasury market. So, the future derivatives have a major role in contributing to the treasury market liquidity.

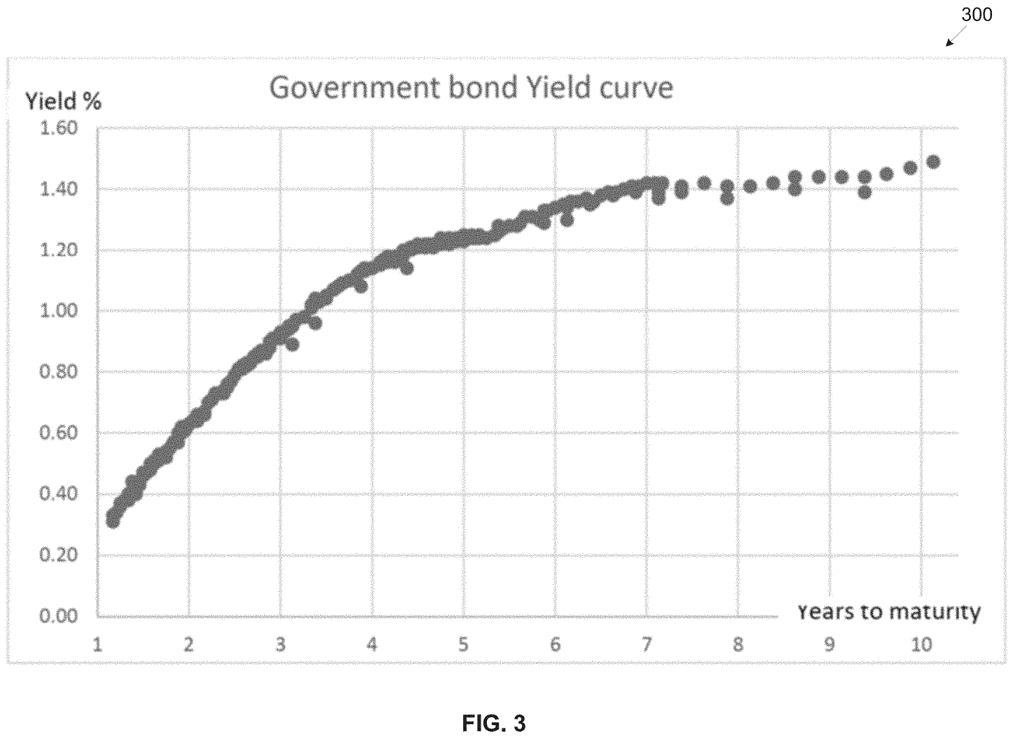

Reference is now made to FIG. 3, which is a graph chart of a yield curve of exemplary US government treasury bonds.

Graph chart 300 illustrates a section (part) of the US treasury yield curve of treasury bonds, for example, bonds up to 10 years where each dot in the graph represents a treasury bond.

It should be noted that the graph chart 300 is exemplary and its yield curve reflects a normal stable market. However, the yield curve may be different for other market conditions, for example in a stress case, such as an unstable market, a market suffering an economic and/or trust crisis and/or the like where long term yield may be predicted to decline compared to the shorter term. In such cases the yield curve may have different shape and/or characteristic, for example, a flat line, an inverted slope and/or the like. Moreover, the shape of the yield curve may also change regularly in normal market conditions and may be influenced from new data arriving to the market such as monetary or fiscal decisions, economic data etc.

In the treasuries futures market, each future is assigned to a specific treasury bond with a time to maturity that reflects the time to maturity that the relying future derivative represents. The underlying bond, in which each future will trade upon its price, is determined by a mechanism which picks the “cheapest to delivery” bond out of few bonds with similar maturity periods. Each future derivative is therefore assigned to one specific treasury bond which thus serves as the underlying asset for the respective future derivative. In particular, future derivatives in different parts of the yield curve are assigned to specific treasury bonds selected according to the maturation period defined by the future derivatives.

Trading derivatives based on the yield curve of the treasury bonds which expresses the yield for different maturity periods (yield to maturity) may present major advantages. First, different parts of the yield curve (i.e., different maturation periods) are exposed to the traders for trading derivative contracts (futures). Moreover, traders may easily shift exposure between different parts of the yield curve by using the appropriate futures. In addition, traders may assess and adjust their exposure based on their estimates of the future shape of the yield curve, for example, steepening curve, flattening position of the curve and/or the like.

Applying the same approach for trading derivatives relying on corporate bonds may be highly desirable for several reasons. First, the derivatives trade may significantly improve the poor daily traded volume (liquidity) of the corporate bond market. Trading corporate bonds market based derivatives may also open investment avenues involving higher risk with higher potential profits.

Some attempts and methods were therefore made to enable trade of derivatives relying on corporate bonds. For example, the Chicago Board Options Exchange (CBOE) launched corporate credit futures which traces the total return of the iBoxx USD investment grade corporate benchmark index and the iBoxx high yield developed markets index. Another example is the IHS Markit which launched a few Over-the-Counter (OTC) corporate credit derivatives in the form of standardized total return swaps which replicate the performance of several corporate indices like the iBoxx USD Domestic Corporate and the iBoxx EUR Corporate. Another example is Bloomberg which launched a total return swap to replicate the performance of the Bloomberg US Corporate index

All the corporate bonds derivatives currently available in the market show very limited success if at all and have a trade volume of just a few million USD a day. This failure may be traced to one of the fundamental limitations common to the existing corporate bonds derivatives which is the fact that these derivatives (futures, swaps) replicate the total performance of specific corporate bond indexes which include bonds from all over the curve, with different times to maturity (maturation periods). This is significantly different from the derivatives (futures) in the treasuries market where each derivative represents the yield of a specific maturation period (time to maturity) over the treasury yield curve.

Contrary to the government issued treasury bonds, the corporate bonds are issued by a plurality of different companies which may be characterized by very different attributes, for example, different sectors, different credit ratings, to name just a few. In addition, the amount outstanding (size) of the bonds issues made by the companies may vary and in general may be significantly smaller compared to the government issued treasury bonds. A comparison between US treasuries and the corporate bonds market is demonstrated in table 1 below.

TABLE 1

| | US treasury market | US corporate market |
|---|---|---|
| Issuer | One (US Government) | Hundreds (Companies) |
| Credit Rating | AAA | Differs from C to AAA |
| | | (20 different ratings) |
| Sector | One (Government) | A variety of sectors (e.g., |
| | | finance, Industry, Energy, |
| | | Utilities, etc.) |
| Number of issues | ~200 | Thousands (hundreds of |
| | | companies, each issuing |
| | | multiple bonds) |
| Size of Issues | Average of 70 Billion | Average of <1 Billion USD |
| | USD per issue | per issue |

Corporate bonds are typically traded based on spread yield which is the yield of a spread (difference) between the yield of a corporate bond and the yield of a corresponding treasury bond having the same maturity period, i.e., the same time to maturity.

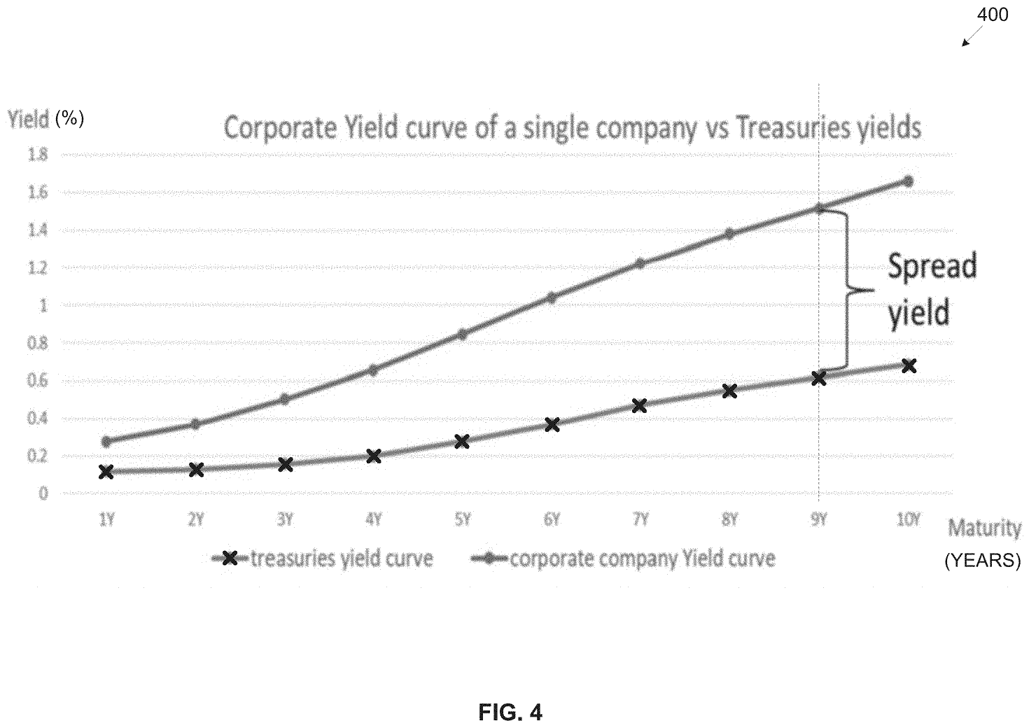

Reference is now made to FIG. 4, which is a graph chart of a yield curve of an exemplary corporate company bond vs. US government treasury bonds. Graph chart 400 illustrates the yield curve of a single corporate company and the yield curve of the treasury bonds market.

A spread yield, i.e., a difference may be measured between the yield curve of the corporate company bond and the yield curve of the treasury bonds market at one or more points of the curves. In particular, the spread may be measured between the curves at the common maturation periods. For example, as shown in the graph chart 400, the spread is measured for a 9 years maturity corporate bond yield vs. a corresponding 9 years maturity treasury bond.

The spread reflects the additional premium yield given for taking the risk of investing in a corporate company. The risk may comprise the risk of default of the corporate company, i.e., an inability of the company to pay the bonds scheduled payments on time, if at all, as well as the liquidity risk involved with the purchase of a corporate bond, i.e., difficulty to sell the bond when needed in a reasonable market price due to low liquidity in the market. It is a known fact that for investment grade companies, most of the spread reflects the liquidity risk associated with these bonds, since their probability of default is extremely low. Traders may negotiate the spread yield of a corporate bond and trade based on it and may further agree on the treasury yield component of it.

Evidently, while trading the spread yield of a single corporate company bond may be straight forward, trading the spread yield of the corporate bond market based on derivatives relying on just a single corporate bond, similar to the method in the treasury futures market, may be impossible since no single corporate bond may be representative of the entire corporate bond market due to the reasons elaborated herein before.

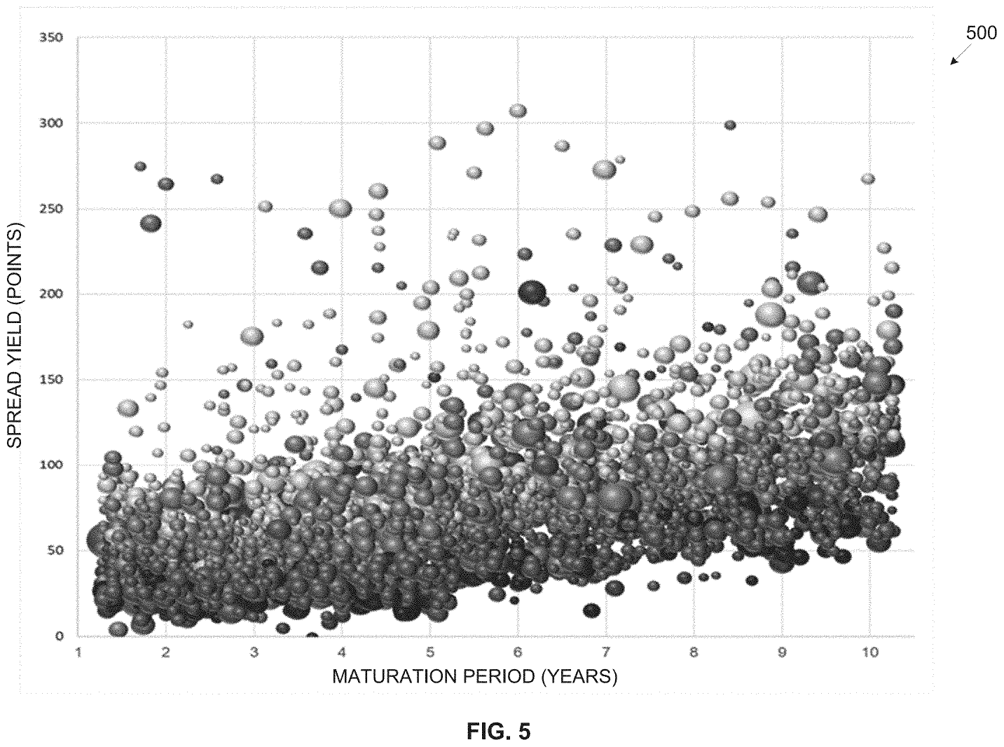

Reference is now made to FIG. 5, which is a graph chart of spread yield vs. maturity for a plurality of corporate companies, according to some embodiments of the present invention.

Graph chart 500 illustrates a plurality of corporate bonds issued by a plurality of corporate companies in terms of basis points vs. maturation period, where each basis point may equal, for example, a 0.01% yield. Each circle in the graph chart 500 represents a respective issue of bonds by a corporate company. The size of each circle reflects the size (amount outstanding) of the bonds issued in the respective issue. The color of each circle reflects the credit rating of the corporate company which issued the respective issue where darker color indicates a higher credit rating and lighter color indicates a lower credit rating. A dark circle may therefore indicate that the respective bond is issued by a corporate company having high credit rating and thus involves lower risk and hence a lower spread yield. A light circle, on the other hand, may indicate that the respective bond is issued by a corporate company having low credit rating and thus involves higher risk and hence a higher spread yield.

As evident in the graph chart 500, thousands of bonds having different sizes and colors may be scattered across the chart due to the diverse characteristics of the corporate bonds market described herein before.

Obviously, unlike the treasury future derivatives, where each future may be assigned to a specific bond on the curve, it is impossible to do the same for the corporate bond market where at each maturation period (time to maturity) there may be many bonds of many companies with different ratings and sectors such that no single corporate bond may, at its own, represent the corporate bond market for the respective maturation period.

Moreover, the low liquidity of each single corporate bond, may also make it ineffective and practically unrealistic to use a single corporate bond to represent the spread yield of the corporate bonds market for a designated maturation period and serve as an underlying asset for a derivative. The low liquidity of the corporate bonds may be reflected by the fact that the average daily traded volume of a single bond in the corporate bond market is about 4 million USD vs. about 2.5 billion USD for a corresponding treasury bond.

According to some embodiments of the present invention, in order to overcome the limitations described herein before for the corporate bond market, representative spread yields are created for different maturation periods (time to maturity) along the spread yield curve of the corporate bond market to serve as underlying assets for corporate bonds derivatives.

Reference is made once again to FIG. 1.

As shown at 102, the process 100 starts with the server 202, specifically the computing engine 240 of the corporate bonds derivatives trading platform 210 creating one or more baskets of corporate bonds to serve as the underlying assets for one or more derivative (future) contracts, for example, a future contract (interchangeably designated future), a forward, and a swap and/or the like.

Each basket is created for a certain predefined maturation period which may follow the maturation periods commonly used by corporate companies to issue new corporate bonds and thus more liquid, for example, 2 years, 5 years, 7 years, l0 years and/or the like.

Each basket may therefore comprise a plurality of corporate bonds, for example, 150, 200, 250 and/or the like having substantially similar maturation periods. In particular, the maturation periods of the corporate bonds included in the respective basket are within a predefined range extending a predefined period before and after the certain predefined maturation period for which the respective basket is created. The predefined range may be, for example, 3 months, 6 months, 8 months and/or the like.

The predefined range may be set such that it is sufficiently tight to effectively and accurately serve as an underlying asset for the respective maturation period, but also may be wide enough to comprise a large number of corporate bonds to serve as a representative group for the corporate bond market at that maturation period (e.g. a range of 3 month prior and after the basket maturation period will include abought 150-250 bonds from all sectors and ratings and therefore its average spread yield will be a good representative of the corporate bond market for that maturation period).

For example, assuming a certain basket is created for a 5 years maturation period. Further assuming that the predefined range is set for 6 months extending 3 months before the 5 years maturation period and 3 months after the 5 years maturation period. In such case, the computing engine 240 may create the certain basket to include a plurality of corporate bonds having maturation periods which is within the 6 months range from the 5 years maturation period, namely 4.75 years and 5.25 years.

Each of the baskets created by the computing engine 240 is configured to expire at an expiration day of the derivative contract(s) relying on the respective basket. For example, assuming a certain derivative contract relying on a certain basket is set to expire in 6 months, the certain basket will also be valid for 6 months and will expire at the expiration day of the relying derivative contact(s).

During the time when each basket is valid there is no change to a composition of the respective basket. This means that from a creation day of each basket until the expiration day of the derivative contract(s) relying on the respective basket there is no change to the corporate bonds included in the respective basket, meaning that no bonds are added to the respective basket and no bonds are excluded from the respective basket.

The computing engine 240 may apply one or more predefined inclusion criteria for selecting the corporate bonds to be included in one or more of the baskets. The inclusion criteria may be applied to achieve one or more objectives, for example, limit the number of corporate bonds included in each basket, for example, 150, 200, 250 corporate bonds and/or the like, ensure sufficient liquidity of the basket, avoid bonds issued by low credit rating corporates, focus on certain sectors and/or the like.

For example, a certain inclusion criterion may define one or more credit rating criteria. An exemplary credit rating criterion may define that one or more of the baskets may include only corporate bonds issued by corporate companies with credit rating exceeding a certain level, for example, >BB+ credit rating, to include only Investment Grade bonds. In another example, a certain inclusion criterion may define one or more bond issue size criteria. An exemplary issue size criterion may define that one or more of the baskets may include only corporate bonds issued in an issue exceeding a predefined issue size (amount outstanding), for example, >300 million USD to avoid inclusion of bonds which are not included in major corporate bond indexes. In another example, a certain inclusion criterion may define one or more liquidity criteria. An exemplary liquidity criterion may define that one or more of the baskets may include only corporate bonds having an average daily trade volume exceeding a certain threshold value for the last 3 months before its inclusion in the basket. In another example, a certain inclusion criterion may define one or more sector criteria. An exemplary sector criterion may define that one or more of the baskets may not include corporate bonds issued by corporate companies of a certain sector, for example, banking, to only include industrial corporate bonds.

Moreover, in order to avoid scenarios in which bonds included in one or more of the baskets are called-out, one or more of the predefined inclusion criteria may define including in the baskets only corporate bonds which have a call option in a period which is smaller than a predefined period before the maturity date of the respective corporate bond. For example, the predefined inclusion criteria may define that one or more corporate bonds having call option period of up to 3 months before the maturation period (maturity date) may be included in one or more of the baskets.

Optionally, the predefined inclusion criteria may define that one or more corporate bonds whose coupon changes from fixed to float on the first call date, may be included in one or more of the baskets even if their call option period is higher, for example, up to 1 year prior to the maturation period.

Moreover, a compensation mechanism may be set to compensate one or more of the traders 208, paid by the other trade 208, for one or more corporate bonds that are removed from one or more of the baskets on which one or more of the derivative contracts rely, like in the case of a merger, an acquisition, and/or the like. The compensation may be computed or determined according to one or more compensation rules. For example, the compensation may be computed by calculating the difference in the price of the derivative based only by the effect of the removed bond on the average spread yield of the basket, and determining the compensation based on that price difference.

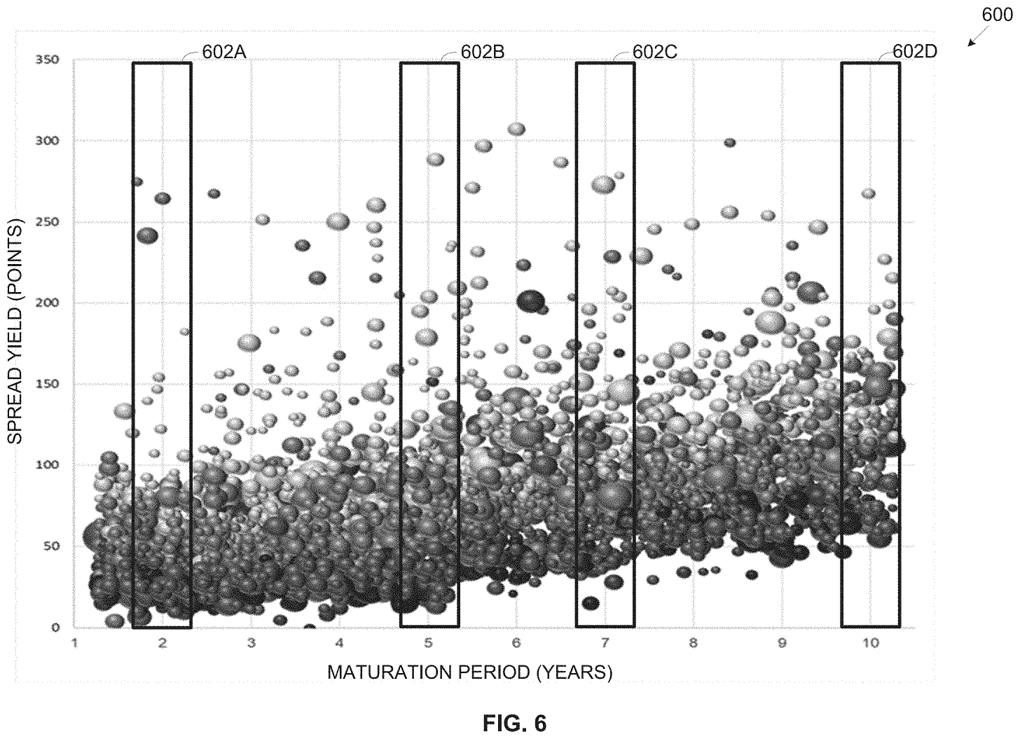

Reference is now made to FIG. 6, which is a graph chart of spread yield vs. maturity for a plurality of corporate companies illustrating a plurality of baskets of corporate bonds created to serve as underlying assets for derivative contracts, according to some embodiments of the present invention.

An exemplary graph chart 600 such as the graph chart 500 presented herein before, may be used by a computation engine such as the computing engine 240 of a corporate bonds derivatives trading platform such as the corporate bonds derivatives trading platform 210 executed by a server such as the server 202 to create one or more basket 602 of corporate bonds comprising a plurality of corporate bonds selected according to one or more of the predefined inclusion criteria.

As seen, the computing engine 240 may create the baskets 602 for one or more maturation periods, for example, a basket 602A for a 2 years maturation period, a basket 602B for a 5 years maturation period, a basket 602C for a 7 years maturation period, a basket 602D for a 10 years maturation period and so on. Each of the baskets 602 may therefore include a plurality of corporate bonds having maturation periods which are within the predefined range extending a predefined period before and after the respective maturation period. For example, assuming the range is set for 6 months, i.e., 3 months before and after the respective maturation period, the basket 602A may include a plurality of corporate bonds having maturation periods between 1.75 years and 2.25 years, the basket 602B may include a plurality of corporate bonds having maturation periods between 4.75 years and 5.25 years, the basket 602C may include a plurality of corporate bonds having maturation periods between 6.75 years and 7.25 years, and the basket 602D may include a plurality of corporate bonds having maturation periods between 9.75 years and 10.25 years.

Reference is made once again to FIG. 1.

As shown at 104, the computing engine 240 may compute an average spread yield and an adjusted average spread duration for each of the baskets 602.

The computing engine 240 may compute the average spread yield of each basket 602 having a respective predefined maturation period by averaging a plurality of individual spread yields of the plurality of corporate bonds included in the respective basket 602 where each of the plurality of individual spread yields is computed with respect to the treasury yield curve as described herein before. The computing engine 240 may compute the individual spread yields using one or more methods known in the art, for example, Bloomberg BVAL, Marketaxess CP+, and/or the like.

Specifically, the computing engine 240 may compute the average spread yield of each basket 602 based on a weighted average of the plurality of individual spread yields of the plurality of corporate bonds included in the respective basket 602. The computing engine 240 may assign a weight to the individual spread yield of each corporate bond of each basket 602 according to the contribution of the respective corporate bond to the respective basket 602. For example, the weight assigned by the computing engine 240 to the individual spread yield of each corporate bond may be based on a market value of the respective corporate bond with respect to a market value of the entire respective basket 602, i.e., the market value of all of the corporate bonds included in the respective basket 602.

After assigning weights to the plurality of individual spread yields of the plurality of corporate bonds included in each basket 602, the computing engine 240 may compute the weighted average spread yield of the respective basket 602 by averaging the weighted individual spread yields.

The computing engine 240 may compute the adjusted average spread duration of each basket 602 by averaging a plurality of individual adjusted spread durations of the plurality of corporate bonds included in the respective basket 602. The adjusted average spread duration computed for each basket 602 reflects the weighted average effective years to maturity of the spread yield component of the corporate bonds included in the respective basket 602.

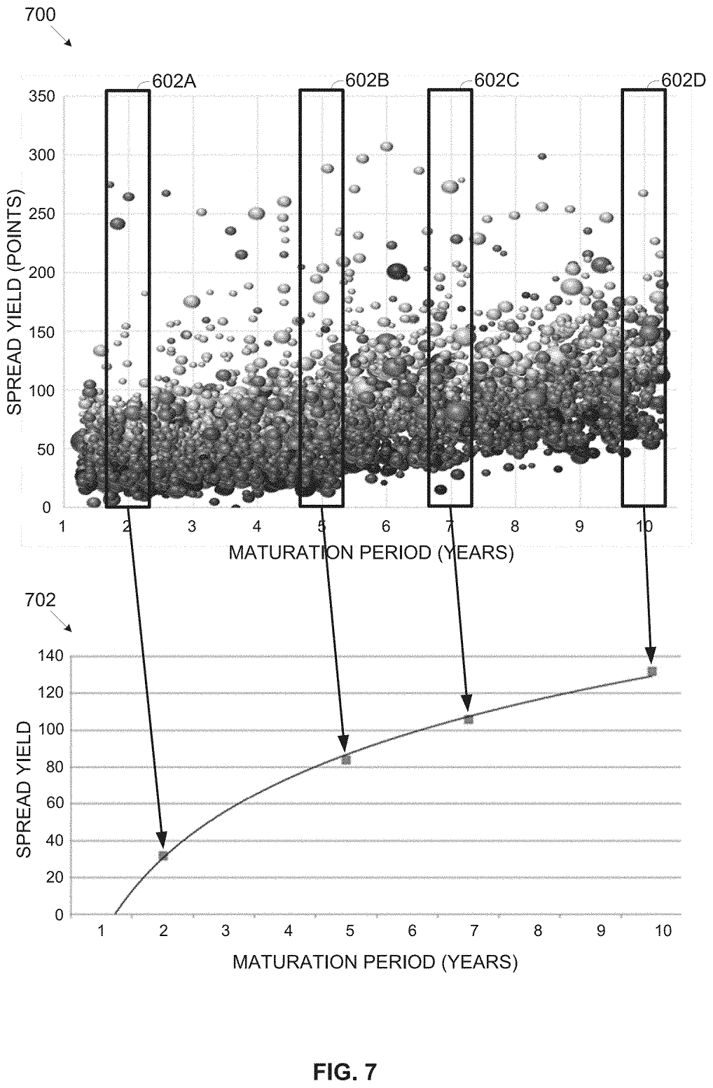

Reference is now made to FIG. 7, which is a graph chart illustrating a spread yield curve created for corporate bonds market based on spread yield computed for a plurality of baskets of corporate bonds, according to some embodiments of the present invention.

An exemplary graph chart 700 such as the graph chart 600 presented herein before, may be used by a computation engine such as the computing engine 240 of a corporate bonds derivatives trading platform such as the corporate bonds derivatives trading platform 210 executed by a server such as the server 202 to create one or more basket 602 of corporate bonds comprising a plurality of corporate bonds selected according to one or more of the predefined inclusion criteria.

The computing engine 240 may further create an extrapolated spread yield curve 702 for the corporate bonds market for a plurality of maturation periods (time to maturity) based on the spread yields computed for the plurality of baskets 602 in graph chart 700 where each basket corresponds for a respective maturation period, for example, the basket 602A for 2 years maturation period, the basket 602B for 5 years maturation period, the basket 602C for 7 years maturation period, the basket 602D for 10 years maturation period and so on.

As evident, the average spread yield computed for each basket 602 may serve as an underlying asset for one or more derivative contracts for the maturation period of the respective basket 602. Moreover, creating the plurality of baskets 602 for the plurality of maturation periods (time to maturity) may form a tradable corporate bonds spread yield curve that may come in addition to the already traded (via futures) yield curve of the treasury bonds market as discussed herein before.

It is important to mention that each of the yield curves, i.e., the treasury yield curve and the corporate spread yield curve, may behave independently and are influenced from various factors in a deferent magnitude or direction. For example, the treasury yield curve may be more directly affected from monetary policy while the spread yield curve may be more influenced from corporate forecasted profitability, corporate leverage and so on. Also, for example, an anticipated recession may bull-flatten the treasury yield curve while in contrary bear-steepen the corporate spread yield curve.

That may allow the traders 208, via derivative contracts, to build and shift positions throughout the spread yield curve of the corporate bond market as may be done by future derivatives relying on the treasury bonds' yield curve.

The price of each derivative relying on the average spread yield of a certain basket 602 may be computed using the average spread yield and the adjusted average spread duration computed by the computing engine 240 for the certain basket 602.

As shown at 106, the server 202 may transmit the average spread yield and the adjusted average spread duration computed for each of the basket(s) 602 to the client devices 204 used by the traders 208. The server 202 may further transmit trading information relating to one or more derivatives contracts relying on the average spread yield which are offered and bid for by one or more of the traders 208 via the trading SW agent 220 executed by their respective client devices 204.

As shown at 122, which is the first step of the process 120 conducted by the trading SW agents 220 executed by the client devices 204 used by the traders 208, the trading SW agents 220 may receive the average spread yield and the adjusted average spread duration computed for each basket 602 and may further receive the trading information relating to the relying derivatives contract(s).

In particular, as shown at 108, the render engine 242 of the corporate bonds derivatives trading platform 210 executed by the server 202 may instruct the GUI of the trading SW agents 220 executed by the client devices 204 of the traders 208 to display the average spread yield and the adjusted average spread duration computed of each of the basket(s) 602 for their maturation period(s). The render engine 242 may instruct the trading SW agents 220 to display the average spread yield and the adjusted average spread duration on each individual basket 602, of multiple baskets 602 and/or of all of the baskets 602, in one or more layouts, for example, a spread yield chart such as the spread yield chart 702, a table, a list and/or the like.

The render engine 242 may further instruct the GUI of the trading SW agents 220 to display the trading information relating to the average spread yield of each basket 602 having a respective maturation period and/or to derivative contracts relying on the average spread yield. The displayed trading information which may be received at least partially from the traders 208 may include, for example, best offers and bids for the average spread yield of one or more of the baskets 602. The displayed trading information may further include size of the derivative contracts (each contract in a pre-defined size, e.g., one million USD per contract) which are offered and/or bid for by the traders 208.

The trading information may dynamically change according to offers and bids received from the traders 208 for one or more derivative contracts based on the average spread yield of one or more of the baskets 602. The render engine 242 may therefore transmit to SW agents 220 the trading information relating to active derivative contracts which may change dynamically and instruct the GUI of the trading SW agents 220 to display the updated trading information.

As shown at 124, each SW agent 220 may adjust its GUI presented via the user interface 256, for example, screen of its executing client device 202 and/or instruct the client device 204 to adjust the GUI to display the average spread yield and the adjusted average spread duration of the basket(s) 602. The SW agent 220 may further adjust its GUI to display the trading information relating to the average spread yield and/or to the relying derivative contact(s).

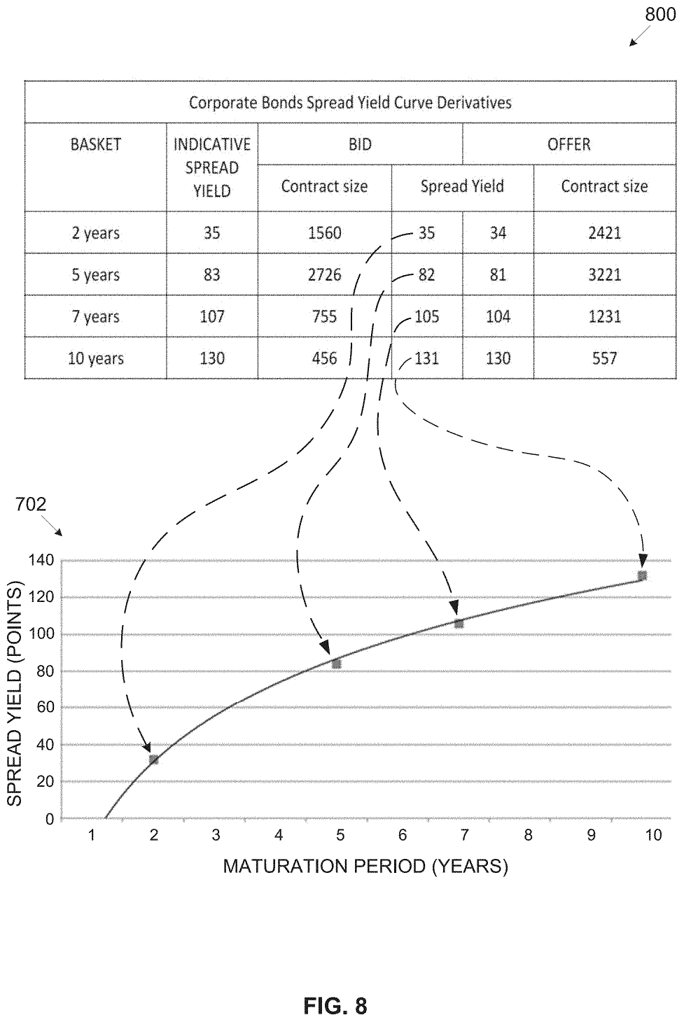

Reference is now made to FIG. 8, which is a graph chart illustrating trading information visualization for derivative contracts relying on a spread yield computed for a plurality of baskets of corporate bonds, according to some embodiments of the present invention.

A render engine such as the render engine 242 of a corporate bonds derivatives trading platform such as the corporate bonds derivatives trading platform 210 executed by a server such as the server 202 may instruct a trading SW agent such as the trading SW agent 220 to display trading information, for example, a table 800 listing currently active derivative contracts traded based on the average spread yield curve of one or more of the baskets 602 serving as the relying asset expressed in graph chart 702.

The table 800 may be displayed by a GUI of the trading SW agent 220 optionally together with the graph chart 702 via a user interface such as the user interface 256, for example, a screen of one or more client devices such as the client devices 204 used by one or more traders such as the traders 208.

As seen, the table 800 may include an indicative spread yield which is the average spread yield computed by a computing engine such as the computing engine 240 for each basket 602 in the graph chart 702 having a respective maturation period, for example, 2 years, 5 years, 7 years and 10 years. The table 800 may further include the size of the OFFER derivative contracts (each contract in a pre-defined size, e.g., one million USD per contract) offered for sale by one or more of the traders 208 and the size of the BID derivative contracts which one or more of the traders 208 offers to buy. As seen, each offered and bid derivative contact may indicate a respective spread yield set by the respective trader 208 who placed (submitted) the offer/bid.

Reference is made once again to FIG. 1.

As shown at 126, based on the trading information displayed by the GUI of the trading SW agents 220, one or more of the traders 208 may insert one or more bids and/or offers for one or more derivative contracts relying on the spread yield of one or more of the baskets 602 for a respective maturation period.

The traders 208 may use one or more of the HMI interfaces available in the user interface 256 of their client device 204 to interact with the trading SW agent 220.

As shown at 128, one or more of the client devices 204 may transmit to the server 202, specifically to the corporate bonds derivatives trading platform 210, the offers and bids inserted by their respective using traders 208 for one or more of the derivative contracts relying on the spread yield of one or more of the baskets 602.

As shown at 110, the server 202 may receive from the client devices 204 the offers and bids for the derivative contract(s). Specifically, the corporate bonds derivatives trading platform 210 may receive the offers and bids for the derivative contract(s) transmitted from the client devices and more specifically, the trade engine 244 may receive the plurality of offers and bids for one or more of the derivative contracts relying on the average spread yields of one or more of the baskets 602.

As shown at 112, the trade engine 244 may broker between the plurality of bids and offers received for one or more of the derivative contracts to create the respective contract(s) accordingly between the respective bidding and offering traders 208.

As stated herein before, the derivative contracts relying on the average spread yields of the baskets 602 may include practically any type of derivative such as, a future contract, a forward, a swap and/or the like. Moreover, the derivative contracts may typically be Non-Deliverable Forward (NDF) type contracts due to the average low illiquidity of the corporate bonds which may make unrealistic the physical delivery of the bonds included in the corresponding basket, from the selling trader 208 to the buying trader 208 at expiration date of the derivative contract.

Cash transactions and settlements between the traders 208 may be done in the same manner derivative contracts are traded in futures exchanges or Over the Counter (OTC) trading.

The trade engine 244 may apply one or more methods for computing a price of each of the derivatives (derivative contacts). While the computation may depend on the type of the derivative contract, i.e., a future, a swap or other form of derivative, the basic computation principles applied by the trade engine 244 may be similar. Naturally, the longer is the maturation period, i.e., the longer is the time to maturity of the traded (basket) spread yield, the more sensitive is the price to spread yield changes.

Optionally, in order to simplify the computation of the price of the derivatives, the derivative contacts may be considered and/or assumed to be zero-coupon contracts.

During the lifetime of each derivative contract until the expiration date of the respective derivative contract, the trade engine 244 may compute a transaction price of the derivative (derivative contract) based on two primary variables:
(1) the adjusted average spread duration of the basket 602 on which the respective derivative contract relies based on the date of the trading day, and
(2) an agreed average spread yield agreed between the selling and buying traders 208.

The trade engine 244 may apply one or more formulations for computing the price of the derivative contracts. For example, the trade engine 244 may compute the price of the derivative contracts according to equation 1 below.

$${PRICE}_{at present day} = \frac{100}{{( 1 + {SPREAD}_{at present day} / 10000 )}^{DURATION ( years )}} \qquad \underline{Equation 1}$$

Where PRICE is the price of the derivative, SPREAD is the average spread yield of the underlying basket 602 that a selling trader 208 and a buying trader 208 have agreed to trade upon trading day (present day) and DURATION is the adjusted average spread duration of the underlying basket 602 at the date of the trading day expressed in time units, for example, years.

At the expiration date of the respective derivative contract, the trade engine 244 may compute a settlement price of the derivative (derivative contract) based only on the underlying basket 602 (on which the respective derivative relies), specifically based on the average spread yield and the computed adjusted average spread duration computed for the underlying basket 602, for example, according to equation 1.

However, value of the average spread yield of the underlying basket 602 may vary during the trade day of the expiration day of the respective derivative contract. The trade engine 244 may therefore apply one or more methods for computing the average spread yield of the underlying basket 602 at the expiration day. For example, the trade engine 244 may compute the average spread yield based on the value of the average spread yield computed at the end of trading day at the expiration day. In another example, the trade engine 244 may compute the average spread yield based on an average of a plurality of samples of the value of the average spread yield computed at a plurality of times during the expiration trading day.

Optionally, since each basket 602 expires at the expiration date of its relying derivative contract, in order to maintain continuity of the corporate bonds spread yield over time to serve as an effective and reliable underlying asset, the computing engine 240 may create one or more new baskets 602 to replace each expired basket 602 for the same maturation period. This means that the new basket 602 corresponds to the same maturation period as that of the expired basket 602.

However, while the new basket(s) 602 and the due to expire basket 602 may correspond to the same maturation period (time to maturity), for example, 2 years, 5 years, 7 years, etc., the new basket(s) 602 are created after the due to expire basket 602 (e.g., 3 months, 6 months, etc.). The computing engine 240 may therefore adjust the maturation period of the new basket(s) 602 compared to the maturation period of the due to expire basket 602 to compensate for the time duration between the creation time of the new basket(s) 602 and the creation time of the due to expire basket 602.

In particular, in order to ensure a smooth continuity, the computing engine 240 may create the new basket(s) 602 at a predefined time before the expiration (date) of the at basket 602 that is due to expire, for example, a month, 2 months, 3 months, and/or the like.

Following is an example of computing the price of a derivative (contract) relying on the average spread yield of a basket 602 of corporate bonds corresponding to a certain maturation period, for example, 5 years.

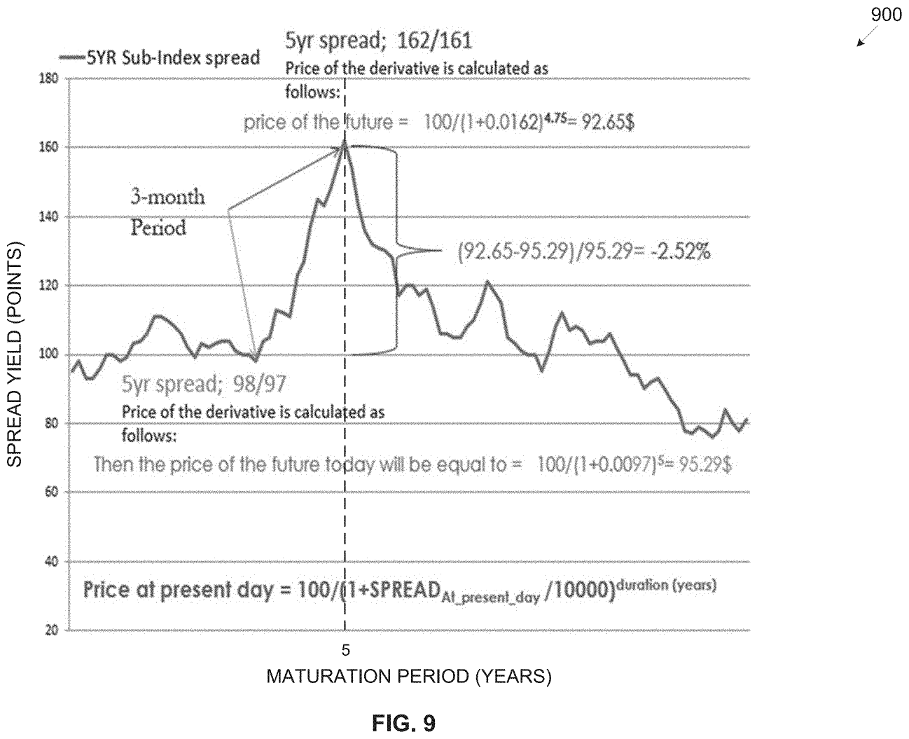

Reference is now made to FIG. 9, which is a graph chart expressing price computation of a derivative contract relying on an average spread yield of a basket of corporate bonds, according to some embodiments of the present invention.

A graph chart 900 illustrates an exemplary average spread yield of an exemplary basket such as the basket 602 having a maturation period (years to maturity) of 5 years. An exemplary derivative contract (designated future in the drawing) traded between traders such as the traders 208 may rely on the average spread yield of the exemplary basket 602. For simplicity, it is assumed that the exemplary derivative contract is a zero coupon contract and a trade engine such as the trade engine 244 may therefore compute the price of the exemplary derivative contract according to equation 1.

As seen in the graph chart 900, a certain trader such as the trader 208 purchased a derivative contract based on the average spread yield of a 5 years underlying basket 602 when the average spread yield was 97 basis points. At the time of purchase the price of the derivative contract (future) computed according to equation 1 may be therefore 95.29$.

Three months later, the derivative contract (future) expires. The average spread yield of the underlying basket 602 at the expiration date is 162 basis points. The price of the of the derivative contract (future) at the expiration day computed according to equation 1 may be therefore 92.65$. it should be noted that the spread duration is adjusted at the expiration day to 4.75 years since the expiration is 3 months (0.25 year) later.

This means that the trader 208 who purchased (bought) the derivative contract lost 2.52% of the value of the future (derivative) even though the spread widened by only 65 basis points (0.65%). This is due to the duration effect. On the other hand, the trader 208 who sold the derivative contract (future), expected (estimated) the spread widening and thus gained 2.52% on the movement of the future.

In the scope of the present invention, it is also worth mentioning the CDX derivative product. Although the CDX product does not rely on corporate bonds, it is commonly used by some market participants to get exposure to corporate credit for certain maturation periods. That is since it relies on the probability of default of Corporate companies and as such, has a correlation with corporate bonds.

However, there are several major differences between the probability of default implied in a single CDS included in a CDX index and the spread yield of a corporate bond. First, the spread yield of a corporate bond not only compensates the investor for the probability of default of the company like the CDS, but also for the lack of liquidity of the corporate bond. Moreover, in investment grade corporate bonds it is a well-known fact that roughly 80% of the spread is related to liquidity compensation and only abought 20% to the default risk. That is why although the average credit rating of the CDX US investment grade index is lower than the average credit rating of an investment grade corporate bond index, the average spread for a given maturation period (maturity) may be actually significantly higher in the corporate bond index compared to the CDX index.

Furthermore, in the US it is not allowed to issue CDS contracts on banks. whereas, in an investment grade corporate bond index, about 36% of the market value of the index is attributed to bank bonds.

For the reasons mentioned above, the CDX derivative has a very problematic correlation with the corporate bond market and its spread always trades significantly below the average spread of a corporate index with similar duration.

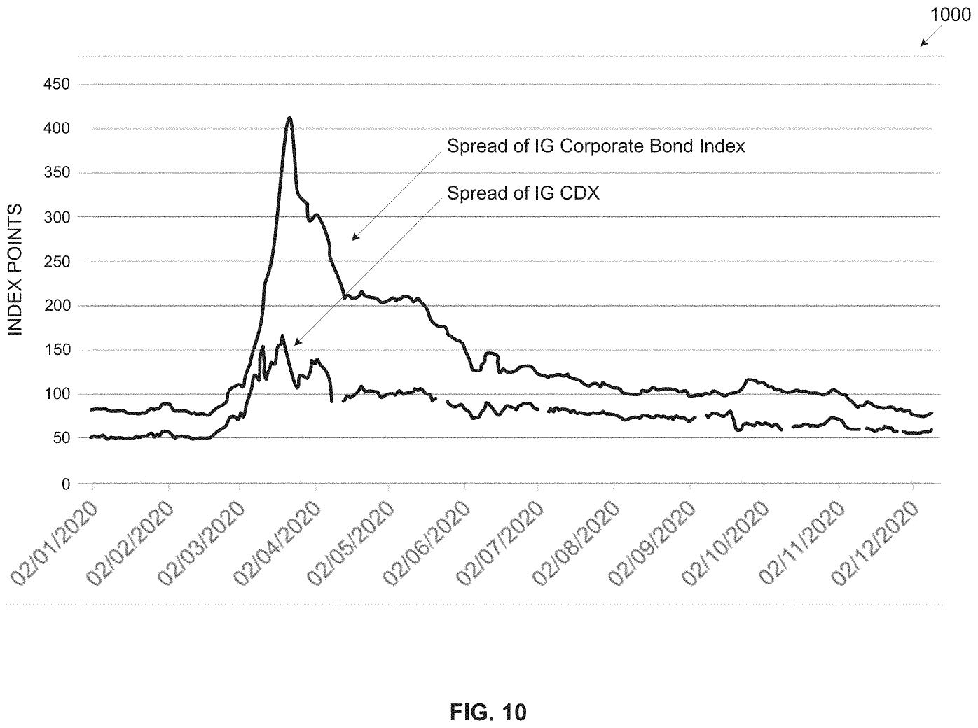

Reference is now made to FIG. 10, which is a graph chart expressing an average spread yield of an exemplary corporate bond index vs. a spread of a CDX index, both having similar maturation periods, according to some embodiments of the present invention.

A graph chart 1000 illustrates a behavior of a spread yield of an investment grade (IG) corporate bond index with a maturation period of 1-10 years (average maturation period of a little less than 5 years) and the spread of a 5 yr IG CDX in 2020 during the out-burst of the Corona crisis.

As seen in the chart 1000, the average spread of the corporate bond index is always significantly higher than the CDX spread, even though they have similar average durations to maturity (maturation periods) and the corporate bond index has a better average credit rating. This is because the CDX does not compensate for liquidity risk but rather only for default as explained herein before.

It is also evident in the chart 1000 that the average spread yield of the corporate bond index widened significantly more than the CDX spread during the burst of the Corona plague, reflecting additional compensation premium for corporate bonds due to the severe lack of liquidity in this market during the crisis, whereas the CDX Index does not compensate at all for illiquidity, as explained herein before.

As result, even though the US IG CDX is an acceptable product and has a decent liquidity of about 10-20 billion USD face value a day (probably because it enables to trade the compensation for the default risk in different times maturity), the US IG CDX still has many deficiencies when integrating it in the management of corporate bond portfolios.

In contrary, the corporate bonds derivatives trading platform 210 will create several spread yield points in different times to maturity to serve as an underlying asset for the derivative contracts. Because each of these spread yields is calculated as the weighted average spread yield of a plurality of corporate bonds included in a respective basket 602, the spread yields, and the derivatives relying on them, may act in unison with the corporate bond market and may reflect a significantly more accurate spread compared to the CDX thus enabling the traders 208 who buy the derivative to receive a much more accurate carry and roll-down of the spread yield curve of the corporate bond market.

In addition, the derivatives relying on the baskets' spread yields may provide a more suitable and correct protection to the trader selling the derivative when volatility rises in the market and larger premium for illiquidity is appropriate. This may be evident in the graph chart 1000 where the spread in the corporate bond market widened 300 basis points at the pick of the Corona crisis, while the spread of the CDX only widened by about 100 basis points.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant systems, methods and computer programs will be developed and the scope of the terms derivatives and derivative contracts are intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, an instance or an illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals there between.

The word “exemplary” is used herein to mean “serving as an example, an instance or an illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A system for trading corporate bonds based derivatives, comprising:
at least one server connected, via at least one network, to a plurality of client devices each comprising at least one processor and memory for executing a receptive one of a plurality of trading software agents of a corporate bonds derivatives trading platform, the at least one server comprising at least one processor and a memory for executing the corporate bonds derivatives trading platform comprising:
a computing engine configured to compute:
an average spread yield of at least one basket of corporate bonds with a predefined maturation period, the average spread yield averages a plurality of individual spread yields of a plurality of corporate bonds included in the at least one basket, each of the plurality of individual spread yields is computed with respect to a treasury yield curve, and
an adjusted average spread duration of the at least one basket averaging a plurality of individual spread durations of the plurality of corporate bonds included in the at least one basket;
a render engine configured to instruct a graphical user interface (GUI) of the plurality of trading software agents to display the average spread yield and the adjusted average spread duration of the at least one basket for the predefined maturation period and best bids and offers for the average spread yield; and
a trade engine configured to:
receive from at least some of the plurality of client devices a plurality of offers and bids for at least one derivative contract relying on the average spread yield of the at least one basket, and
create the at least one derivative contract by brokering between the plurality of offers and bids.

2. The system of claim 1, further comprising creating a plurality of baskets for a plurality of different maturation periods, each of the plurality of baskets comprises a plurality of corporate bonds, and computing a respective average spread yield and a respective adjusted average spread duration for each of the plurality of baskets serving as a relying asset for at least one of a plurality of derivative contracts.

3. The system of claim 1, wherein the at least one basket of corporate bonds comprises a plurality of corporate bonds issued by a plurality of corporates, each of the plurality of corporate bonds has a maturation period which is within a predefined range extending a predefined time period before and after the predefined maturation period.

4. The system of claim 1, wherein no change is applied to a composition of the at least one basket from a day of creation of the at least one basket until an expiration day of the at least one derivative contract relying on the at least one basket.

5. The system of claim 1, wherein the at least one basket of corporate bonds expires at an expiration day of the at least one derivative contract relying on the at least one basket.

6. The system of claim 1, wherein the average spread yield is computed for the at least one basket based on a weighted average of the plurality of individual spread yields, each of the plurality of individual spread yields computed for a respective one of the plurality of corporate bonds is assigned a weight according to a value of the respective corporate bond, the weight of each corporate bond is computed based on a market value of the respective corporate bond with respect to a market value of the entire at least one basket.

7. The system of claim 1, wherein the adjusted average spread duration is computed for the at least one basket based on a weighted average of the plurality of individual spread durations, each of the plurality of individual spread durations computed for a respective one of the plurality of corporate bonds is assigned a weight according to a value of the respective corporate bond, the weight is computed based on a market value of the respective corporate bond with respect to a market value of the entire at least one basket.

8. The system of claim 1, wherein the at least one basket comprises a plurality of bonds each issued in an issue complying with at least one predefined inclusion criteria.

9. The system of claim 1, wherein each of the plurality of corporate bonds included in the at least one basket has a call-out period which is smaller than a predefined period before the maturity date of the respective corporate bond.

10. The system of claim 1, wherein a compensation for each corporate bond pulled-out from the at least one basket is computed according to at least one compensation rule.

11. The system of claim 1, wherein the at least one derivative contract is a member of a group consisting of: a future contract, a forward, and a swap.

12. The system of claim 1, wherein the at least one derivative contract is a Non-Deliverable Forward (NDF) type contract.

13. The system of claim 1, further comprising creating at least one new basket of corporate bonds, serving as a relying asset for at least one new derivative contract, to replace the at least one basket, the at least one new basket corresponds to the maturation period of the at least one basket.

14. The system of claim 13, wherein the at least one new basket is created at a predefined time before expiration of the at least one basket, the at least one new basket having an adjusted maturation period compared to the maturation period of the at least one basket to compensate for the time duration between a creation time of the at least one new basket and the creation time of the at least one basket.

15. The system of claim 1, wherein during a lifetime of the at least one derivative contract until expiration of the at least one derivative contract, a transaction price of the at least one derivative contract is computed based on the adjusted average spread duration of the at least one basket on which the at least one derivative contract relies, the adjusted average spread duration of the underlying at least one basket is computed based on a date of the trade day and an agreed average spread yield of the at least one basket on which the at least one derivative contract relies, the agreed average spread yield is negotiated between counterparties of a transaction of the at least one derivative contract.

16. The system of claim 1, wherein at expiration day of the at least one derivative contract, a settlement price of the at least one derivative contract is computed based on the computed average spread yield of the at least one basket and the computed adjusted average spread duration of the at least one basket.

17. The system of claim 16, wherein the average spread yield of the at least one basket is computed at the expiration day of the at least one derivative contract based on at least one of: the value of the average spread yield computed at an end of trading day at the expiration day, and an average of a plurality of samples of the value of the average spread yield computed at a plurality of times during the trading day at the expiration day.

18. The system of claim 1, further comprising the at least one derivative contract is considered a zero-coupon contract.

19. A computer based method of trading corporate bonds based derivatives, comprising:
using at least one server connected via at least one network to a plurality of client devices each executing a respective one of a plurality of trading software agents of a corporate bond derivatives trading platform, the at least one server comprising at least one processor and memory for executing the corporate bonds derivatives trading platform comprising:
a computing engine configured to compute:
an average spread yield of at least one basket of corporate bonds with a predefined maturation period, the average spread yield averages a plurality of individual spread yields of a plurality of corporate bonds included in the at least one basket, each of the plurality of individual spread yields is computed with respect to a treasury yield curve, and
an adjusted average spread duration of the at least one basket averaging a plurality of individual spread durations of a plurality of corporate bonds included in the at least one basket;
a render engine configured to instruct a graphical user interface (GUI) of the plurality of trading software agents to display the average spread yield and the adjusted average spread duration of the at least one basket for the predefined maturation period and best bids and offers for the average spread yield; and
a trade engine configured to:
receive from at least some of the plurality of client devices a plurality of offers and bids for at least one derivative contract relying on the average spread yield of the at least one basket, and
create the at least one derivative contract by brokering between the plurality of oilers and bids.
